(19) United States
(12) Patent Application Publication
(10) Pub. No.: US 2013/0033041 A1
(43) Pub. Date: Feb. 7, 2013

(54) Fluid displacement methods and resultant machines

(71) Applicants: David Gregory Booher, Sparks, NV (US); Wojciech Polanski, Reno, NV (US)

(72) Inventors: David Gregory Booher, Sparks, NV (US); Wojciech Polanski, Reno, NV (US)

(21) Appl. No.: 13/566,998

(22) Filed: Aug. 3, 2012

Related U.S. Application Data
(60) Provisional application No. 61/515,118, filed on Aug. 4, 2011.

(51) Int. Cl. F01D 15/10; F16K 31/12

(52) U.S. Cl. 290/52; 137/1

(57) ABSTRACT

We have invented multiple methods of fluid displacement that enable a device to become buoyant at depth. It is accomplished by utilizing a fluid with a greater gravity or pressure, whether naturally occuring or mechanically generated. The first fluid is directed by a valve to displace a lighter fluid from a chamber or container into a second fluid body, with the result that a device at depth within the second fluid body becomes positively buoyant. The positively buoyant device can be utilized for example in energy production, item retrieval at depth or moving an object from the surface to a specific depth and back.

### CROSS REFERENCE TO RELATED APPLICATIONS

This application claims the benefit of U.S. Provisional Patent Application Ser. No. 61/515,118 filed on Aug. 4, 2011. Many different machines have been invented which claim to be able to harness buoyant energy in an efficient and cost effective manner but fail to do so in practical application. While the power of buoyancy is easily understood when a person observes a massive floating cruise ship, the ability to efficiently make a device positively buoyant at depth is not easily understood nor employed in many modern inventions, especially those that seek to utilize buoyancy for energy production. This can be seen in U.S. patent application Ser. No. 11/138,875 where a pumping area is required in order to make a device buoyant. The energy requirements for pumping the water to the top of the inventor's towers would exceed the energy produced.

### FIELD OF THE INVENTION

This application relates to a method and resultant machines for harnessing the energy from buoyancy in order to accomplish a useful purpose such as energy production, object retrieval at depth, moving an item from the surface of a fluid body to a specific depth and more.

Some inventors try to utilize the naturally occuring pressure from a fluid with greater gravity such as U.S. Pat. No. 6,009,707 to Alkhamis. In this invention however a much larger quantity of moving parts is required in order to harness the resultant buoyant energy than is required in our processes and resultant machines. In our processes and resultant machines brakes, weights, and pumps are not needed in order to harness the buoyant force.

In U.S. patent application Ser. No. 11/247,928 to Tung, a large number of moving parts are also needed for the inventor to be able to harness the buoyant force created by fluids with different gravities. Also the positions of the chambers or “air storage hoods” are fixed with regard to their installation location and therefore limit the systems practicality. Furthermore the inventor's machine requires larger amounts of one-way valves, mechanical valves, pullies, and other devices than are required in our machines. In the embodiments of our machines that are vertically orientated they do not require the use of “slippery pillars” in order to guide the buoyant devices as is required by Tung's invention.

In all of the aforementioned prior art the buoyant devices travel a straight path vertically. This orientation requires greater depths within a fluid body than are required by our methods. This also limits their practicality due to the increased pressure that must be overcome when the buoyant device is deeper within the fluid it is immersed in, along with the inherent loss due to air compression at depth. When this is combined with the large amounts of moving parts, naturally the losses from friction will be greater than our systems. Of course the more parts that are required the greater the cost will be for the initial installation and maintenance of the machine. It should also be mentioned that the two previously referenced inventions that utilize naturally pressurized fluid require braking methods in order to stop and fill their buoyant members. This break in the cycle results in an inconsistent energy production that our processes and resultant machines do not suffer from.

Systems that utilize compressed fluids such as air for the purpose of testing waterproof devices, typically require large amounts of energy in order to achieve their desired compression due to air's inherent compressibility, frictional losses, and losses due to heat. An example of this is the amount of energy required by mechanical air compressors. By utilizing our methods, less energy is needed to achieve the same level of compression.

We have designed and tested far superior methods of utilizing buoyant energy over the prior art due to our processes, reduced parts requirements, cost effective parts use, lower fluid pressure, flexibility in parts location, chamber designs and other key points that will become obvious as they are described.

### DRAWINGS

FIG. 1 shows a single vane turbine that is activated using the first method.

FIG. 2 depicts an expandable device that is internally expanded using the first method and a hydraulic cylinder.

FIG. 3 depicts a submersible structure utilizing a drive shaft for harnessing the buoyant for that comes from using the first method.

FIG. 4 illustrates how the first method can be used to either generate power or raise an object within a controlled environment.

### DETAILED DESCRIPTION OF THE INVENTION

The first method uses a first fluid with a greater total gravity or pressure, either naturally occuring or mechanically generated, than any subsequent fluids at the beginning of the process. The first fluid is directed by at least one valve that controls the flow of the first fluid from the valve to said first fluids contact point with an actuating fluid. Said actuating fluid is contained within a predetermined area or device connected to a fluid conveyance line or valve. Said actuating fluid is then directed by a means of fluid conveyance to a device at a predetermined depth within a second fluid body. At this point positive buoyancy of said device is achieved and can be harnessed for many different purposes. For the cycle to be repeated the valve actuates to prevent the flow of the first fluid and simultaneously release the pressure on the system allowing the actuating fluid to be restored and the spent first fluid to be evacuated.

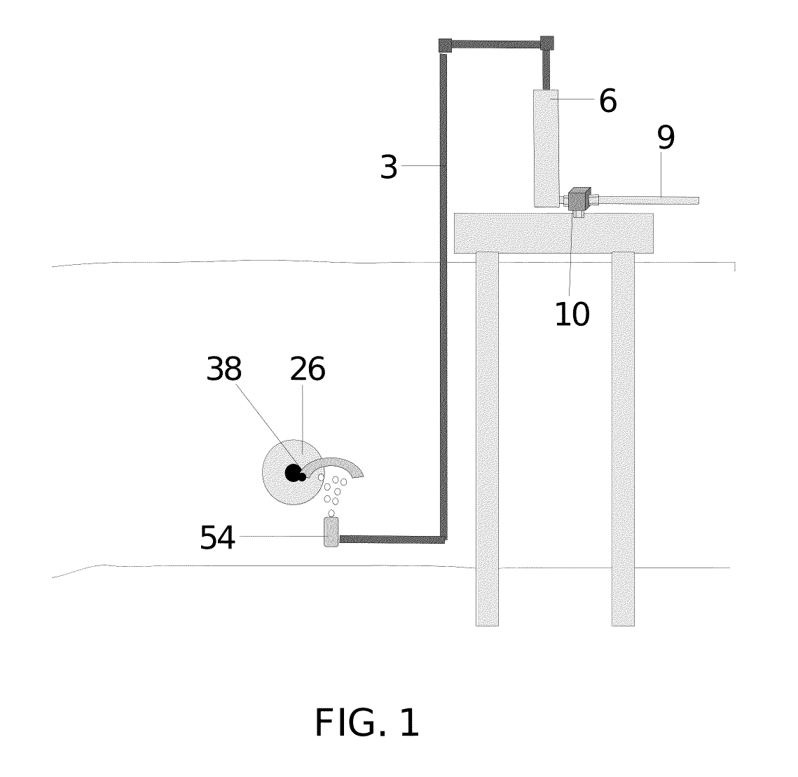

An illustration of how the first method can be utilized is shown in FIG. 1 where tubing or piping 9 conveys the first fluid with the greater gravity/pressure through a three way valve 10 and into a compressible container or chamber 6. As the chamber fills with the first fluid, the actuating fluid within the chamber, such as air in this example, is displaced through a fluid conveyance line 3. Upon exiting the one way valve 54 the actuating fluid enters the second fluid and accumulates in the vane 38 causing it to rise once it accumulates enough air and thereby allowing a generator 26, for example, to harness the energy. Next the three way valve 10 activates thus preventing fluid flow from delivery line 9 while simultaneously draining chamber 6 of the spent first fluid and thereby allowing it to be refilled with air in preparation for the next cycle. While only a single vane is illustrated in FIG. 1, a plurality of vanes making up a turbine can be used to further harness the energy. Also the one way valve is illustrated as an option for this embodiment but is not necessary if the fluid conveyance line 3 begins above the second fluid bodies highest elevation.

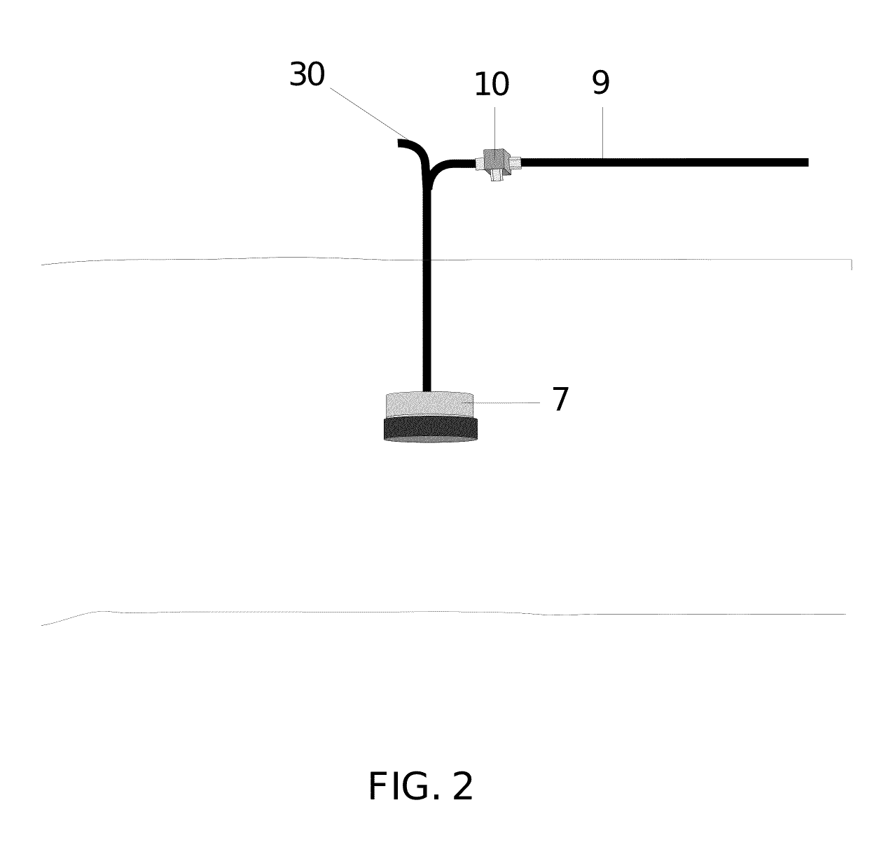

Another embodiment utilizing this first method is illustrated in FIG. 2. Here an expandable chamber 7 having negative buoyancy when collapsed is pictured at depth within the second body of fluid. Many different types of expandable chambers can be used such as bellows, appropriate bladder style bags, rigid walled cylinders and so on. The expandable chamber in this embodiment is a double cylinder design with one cylinder sleeved into the other. It is further equipped with a hydraulically actuated expandable device such as a hydraulic cylinder that is internally located within 7 in this embodiment. Line 9 once again supplies the fluid with the greater gravity or pressure through a three way valve 10 that directs the fluid throughout the cycle. A breather tube 30 allows a light weight fluid medium such as ambient air, to be drawn into 7 during expansion and released during contraction. The cycle begins when the valve 10 opens and thereby pressurizes the hydraulic cylinder within the expandable chamber 7 that is at depth within the second body of fluid, causing the chamber to expand due to the first fluids greater gravity/pressure. Once the chamber rises to the desired depth in the second fluid body the valve 10 activates thus preventing fluid flow from delivery line 9. Simultaneously the hydraulic cylinder within chamber 7 is depressurized and allowed to drain out a port on the valve 10 thereby allowing the expandable chamber to contract due to the ambient fluid pressure of the second body of fluid now being greater than the fluid within 9 after the valve. At this point chamber 7 becomes negatively buoyant again and returns to its starting point for the next cycle. A variety of different machines including generators, pumps, underwater recovery systems and so forth can utilize the buoyant upforce provided by this embodiment.

The second method is similar to the first method but with a different method of expansion for the device surrounded by the second body of fluid. A first body of fluid's gravity/pressure is utilized by a means of fluid conveyance in order to supply enough pressure to actuate a device causing it to contract and simultaneously store energy within at least one of it's parts. Some examples of such devices are hydraulic or pneumatic cylinders with reservoirs, springs and locking levers. The expandable chamber is activated when said chamber descends to a predetermined depth and it's energy storage parts are released causing the device to expand thereby making said chamber positively buoyant in the second fluid. As it ascends or descends in the second fluid the device is a source of kinetic energy that can be harnessed by a variety of mechanical devices or to accomplish different procedures as previously referenced in the first method and it's sample embodiments.

Either method can be augmented with mechanically pressurized fluids such as water that is supplied to a residential or commercial location, in many countries, by a utility company. This unique feature allows the machines utilizing these methods to be able to perform their tasks at a reduced operating cost over similar systems that use air compressors at some point in their process in order to inflate devices at depth. When this is combined with a unique fluid recycling process the ongoing energy expenditure is further reduced. This is achieved by utilizing one of the first two methods previously mentioned but the device that becomes buoyant in the second body of fluid typically has only one fluid conveyance path and cannot typically release the actuating fluid into the second fluid. Some examples of these devices are a bellow, bladder bag, piston pump, plunger pump, hydraulic or pneumatic cylinders, air bag, tubing, telescoping container or other devices that can be used to store and displace a volume of fluid. When the work is accomplished the actuating fluid that was displaced is depressurized by the valve and the greater pressure exerted by the water and/or the expanded buoyancy device causes the actuating fluid to flow back to the container it originated from. At this point the cycle can be repeated.

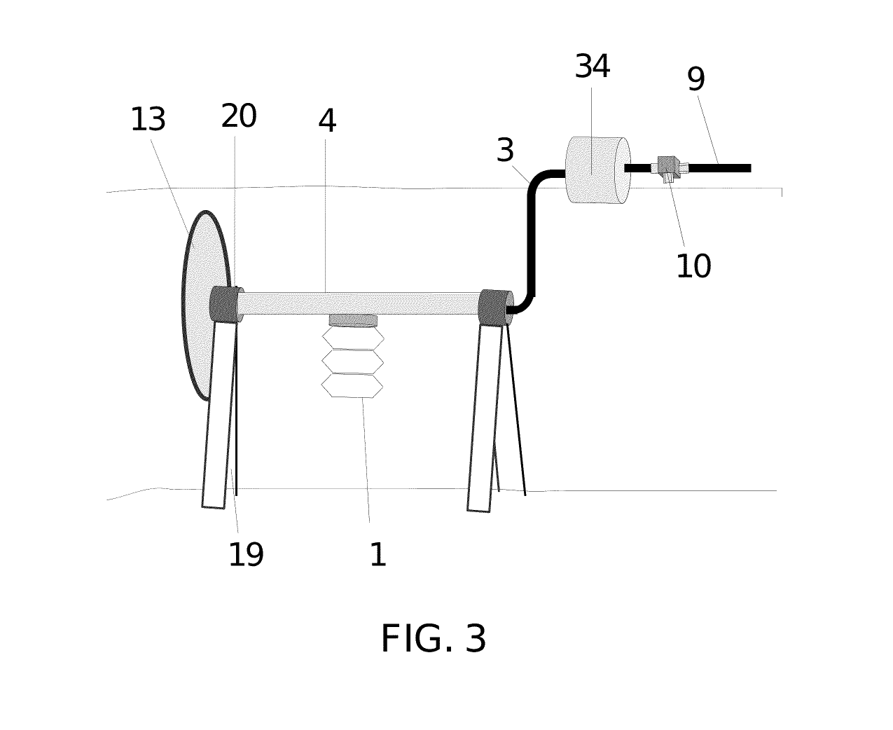

An example of an embodiment utilizing the first method and the fluid recycling method is illustrated in FIG. 3. Here a submersible structure 19 with removable drive shaft stabilizers 20 for retaining and guiding a drive shaft 4 is pictured. On one end of the drive shaft a removable flywheel 13 is attached to transmit the mechanical energy to another device. In this embodiment a cylindrical compression chamber 34 contains the actuating fluid that is displaced when the first fluid is directed by the valve 10 into the chamber. The actuating fluid flows through line 3 to the bellow 1 , causing it to expand and thereby become positively buoyant in the second fluid body. Said bellow being positively buoyant ascends while rotating the drive shaft 4. At a predetermined point in the cycle the valve 10 activates thus preventing further pressurization from line 9 and simultaneously relieves the pressure on said bellow. This action allows the water pressure, the bellow or both to displace the actuating fluid back into the chamber 34. As the chamber is refilled with the actuating fluid the spent first fluid is displaced out a port on the valve. At this point the cycle is free to be repeated.

In many embodiments hydraulic cylinders, pneumatic cylinders, piston pumps and the like can be used to displace the actuating fluid from a container by utilizing the pressure from the first fluid. Doing so can provide a mechanical advantage when the first fluids pressure is sufficient enough to overcome another fluid with greater volume. The same technique is used in machines that utilize hydraulic or pneumatic cylinders such as automotive lifts. The mechanical advantage that comes from a pressurized fluid acting upon the piston within the cylinder provides increased power output allowing the machine to overcome the weight of the vehicle as it ascends. With proper cylinder or piston pump selection the range of applications for efficient utilization of the above mentioned fluid displacement methods can be dramatically increased. For instance low volume high head fluid supplies can still displace large amounts of actuating fluid when combined with hydraulic cylinders and say a piston pump or a pneumatic cylinder. The greater the head height of the first fluid the greater the line pressure will be. When this ample pressure is coupled with a properly selected hydraulic cylinder the relative displacement of the actuating fluid can be increased or even sped up.

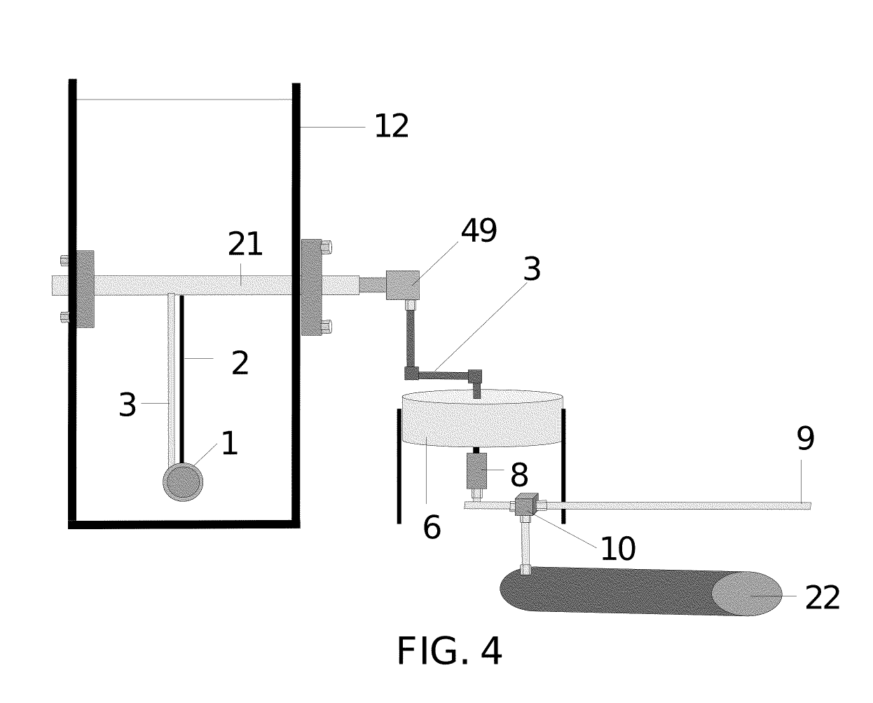

An illustrative example of the benefits provided by said cylinders, piston pumps and the like can be seen when they are coupled with pressurized water that is typically available at a business or residential location. This technique can provide cost effective advantages over using conventional air compression systems for underwater air delivery. As previously mentioned air compressors that typically are driven by gas engines or electric motors require large amounts of energy to achieve compression due to the compressability of air and the inherent losses of high friction, high heat, compression methods. These problems are overcome in a clearly understood example embodiment in FIG. 4 which uses the first fluid displacement method in combination with hydraulic compression and water pressure provided mechanically and finally the actuating fluid recycling method.

In FIG. 4 we see line 9 which delivers the pressurized first fluid to the valve 10. When said valve activates allowing the first fluid to flow into the hydraulic cylinder 8 said cylinder acts upon the compression chamber 6 thereby displacing the actuating fluid within. The actuating fluid flows through the fluid conveyance line 3 into a coupler 49 that directs the fluid through the drive shaft 21 and into the bellow 1. Once said bellow becomes positively buoyant in the second fluid that is contained within the tank 12 it rises to a predetermined point. As the bellow reaches this predetermined point in the tank the valve 10 actuates preventing the flow from line 9 of the pressurized first fluid and simultaneously allowing the spent first fluid contained after the valve to be bled out into a drainage system 22. This decrease in pressure allows the bellow and/or the second fluid body to compress the bellow making it negatively buoyant and return the actuating fluid back to the chamber 6 . Once again the cycle is free to be repeated. Such a system could be used to test functionality for waterproof devices, buoyancy devices, airtight devices and scuba parts just to name a few. By adding a power take off device to the drive shaft such as an electrical generator for example, electricity can be generated.

Many different devices can be incorporated into various embodiments to provide further benefits. For instance flywheels can smooth the rotation of drive shafts and work as a means for power take off to another device. Breather assemblies can also incorporate one way valves. The one way valves would allow for faster draining of the cycled first fluid and with refilling the chamber with the actuating fluid. Various means of fluid control such as valves can provide specific benefits. The fluid control devices can be actuated electronically, pneumatically, mechanically and so on. Quick couplers on fluid conveyance lines can speed assembly and disassembly. The type of material used to make fluid conveyance lines, fasteners, valves, tanks, couplers, support structures, drive shafts and the other devices incorporated within an embodiment can be greatly varied but one who is skilled in the art of applied fluid dynamics and engineering will recognize the material requirements for each application.

1. A method for making a device buoyant within a body of fluid by:
a) utilizing a first fluid with a greater gravity or pressure, whether naturally occuring or mechanically generated;
b) a valve opens allowing the first fluid to enter a chamber containing a lighter fluid and said lighter fluid becomes an actuating fluid as it is displaced into a second fluid body;
c) the actuating fluid next comes into contact with a device thereby making said device buoyant within said second body of fluid;
d) once the device ascends to a predetermined point in said second fluid body the valve closes off from the source of said first fluid and drains the first fluid within said chamber, thereby allowing the cycle to be repeated.

2. A method for making a device buoyant within a body of fluid by:
a) utilizing a first fluid with a greater gravity or pressure, whether naturally occuring or mechanically generated;
b) a valve opens allowing the first fluid to enter a chamber containing a lighter fluid and said lighter fluid becomes an actuating fluid as it is displaced into a device capable of contracting and storing energy from said actuating fluids sufficient pressure;
c) said contracting device sinks within a second body of fluid when it sufficiently contracts enough to become negatively buoyant and at which point the valve closes off from the supply of the first fluid;
d) when the contracted device reaches a predetermined depth it's stored energy is released, causing it to expand and thereby making it buoyant.

3. A machine that utilizes the first method for the purpose of harnessing the buoyant force in order to generate electricity consisting of:
a) a valve for controlling the flow of the first fluid;
b) a chamber containing the actuating fluid;
c) a means for conveying the actuating fluid from said chamber into the second fluid body;
d) a turbine for harnessing the buoyant force of the actuating fluid;
e) a generator that can convert the rotational force into electricity.
